(19) United States
(12) Patent Application Publication
(10) Pub. No.: US 2012/0243720 A1
(43) Pub. Date: Sep. 27, 2012

(54) Auto-Play Audible Publication

(76) Inventors: An-Hsiu Lee, Taipei (TW); Mei-Huei Chiang, Taipei (TW)

(21) Appl. No.: 13/072,748

(22) Filed: Mar. 27, 2011

(51) Int. Cl. H04R 1/02

(52) U.S. Cl. 381/334

(57) ABSTRACT

A novel auto-play audible publication, which enables to play the contents and voice simultaneously without external players; the audible publication is either of book, newspaper, magazine, booklet, leaflet, calendar, card, CD album, notebook, religious scripture/journal; in particular, the audible publication comprises: thin speaker, play panel, control circuit board, speaker driving flexible circuit board and power supply, of which the control circuit board is provided with a memory for storing all audio data in the audible publication; the play panel can be controlled to select the contents and send signals to the control circuit board, and make the speaker driving flexible circuit board output audio effect to the thin speaker for play back. While simultaneous reading and listening, the audible publication also allows learning acoustically the contents and listen to correct voice for a better learning effect.

### BACKGROUND OF INVENTION

1. Field of the Invention

The present invention relates generally to an audible publication, and more particularly to an innovative one which is designed with a player integrating thin speaker and play panel enabling the users to carry it conveniently for audible playing anytime and anywhere.

2. Description of Related Art

The common publications available with vivid patterns and rich contents are generally accessed statically by the readers, but not for the children.

For this reason, a kind of audible book has been developed, to store data into optical disc or other storage device in the computer-based file format; when the users are intended for reading, the book is accessed by means of computer or PDA, etc, making it very inconvenient.

Users may find it inconvenient to carry audible books and players.

### CONTENT OF INVENTION

To make improvement of the audible books for meeting the demands of general public, the objective of present invention is to provide a novel auto-play audible publication that integrates an audible player into a publication, realizing lightweight and portability while audible playing anytime, anywhere without the help of any other electronic player.

### SUMMARY OF INVENTION

In order to accomplish above objective, the inventor has designed an auto-play audible publication, which comprising:

one or more thin speakers, set within the front or back cover;

a play panel, set at either side of the thin speaker, allowing the users to control its functions including: play, pause, stop, repeat, change and page display, etc;

a control circuit board with audio output control and storage functions, provided with a memory for storing all audio data in the audible publication;

a speaker driving flexible circuit board, electrically connected with thin speaker via a transmission line, and used to receive startup signal from the control circuit board to drive the thin speaker for intended audio effect;

a power supply, provided with several batteries connected in series to supply the required electric power; the power supply is also connected with electric device for durable operation.

When the audible publication is used, the play panel is operated to play the corresponding contents, and the audio effect is released via thin speaker for the users.

Said audible publication includes: books, newspapers, magazines, booklets, leaflets, calendars, cards, albums, notebooks and various religious scriptures/journals.

Said memory includes: ROM and flash memory, of which the flash memory allows to update, expand or change the contents via Universal Serial Bus (USB) interfacing.

Said speaker driving flexible circuit board is also fitted with an audio input hole, which is connected to earphone for listening purpose.

The contents, features and efficacies of the present invention will be more readily understood upon a thoughtful deliberation of the following detailed description of a preferred embodiment of the present invention with reference to the accompanying drawings.

### BRIEF DESCRIPTION OF THE DRAWINGS

FIG. 1: a structural view (1) of a preferred embodiment of the auto-play audible publication of the present invention.

FIG. 2: a structural view (2) of a preferred embodiment of the auto-play audible publication of the present invention.

FIG. 3: a structural view (3) of a preferred embodiment of the auto-play audible publication of the present invention.

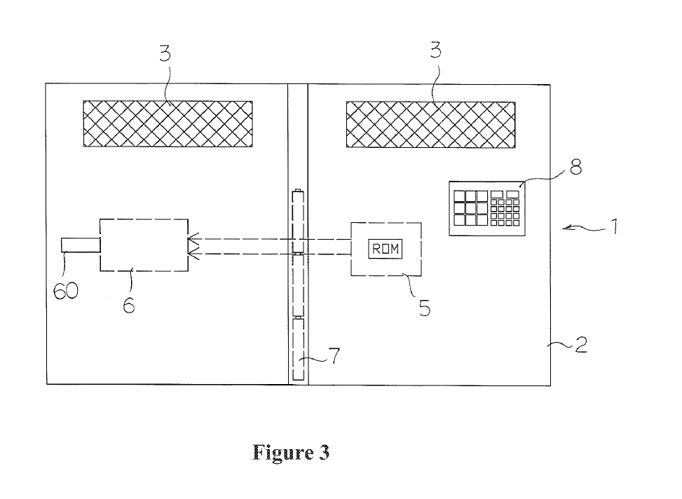

FIG. 4: a structural view (4) of a preferred embodiment of the auto-play audible publication of the present invention.

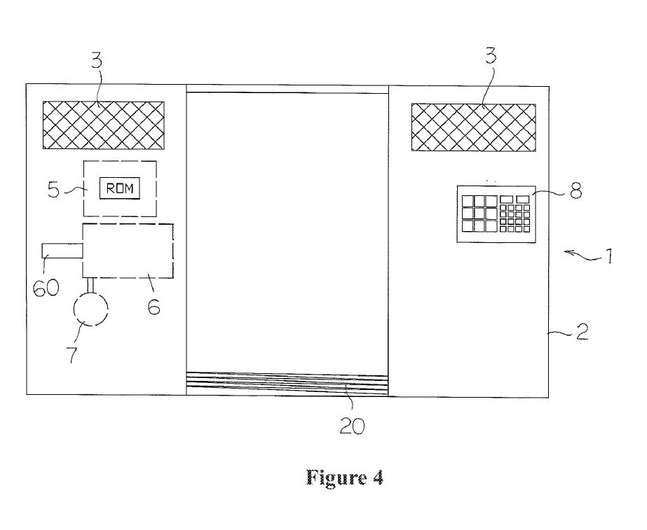

FIG. 5: a structural view of the second preferred embodiment of the auto-play audible publication of the present invention.

FIG. 6: a structural view (1) of the third preferred embodiment of the auto-play audible publication of the present invention.

FIG. 7: a structural view (2) of the third preferred embodiment of the auto-play audible publication of the present invention.

FIG. 8: a structural view of the fourth preferred embodiment of the auto-play audible publication of the present invention.

### DETAILED DESCRIPTION OF INVENTION

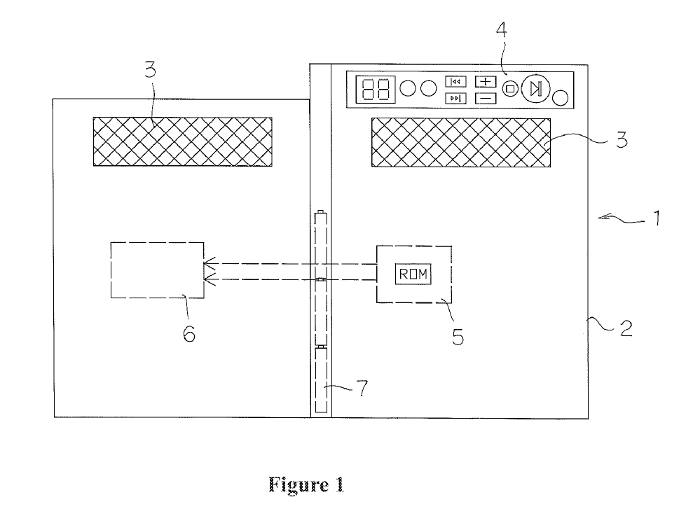

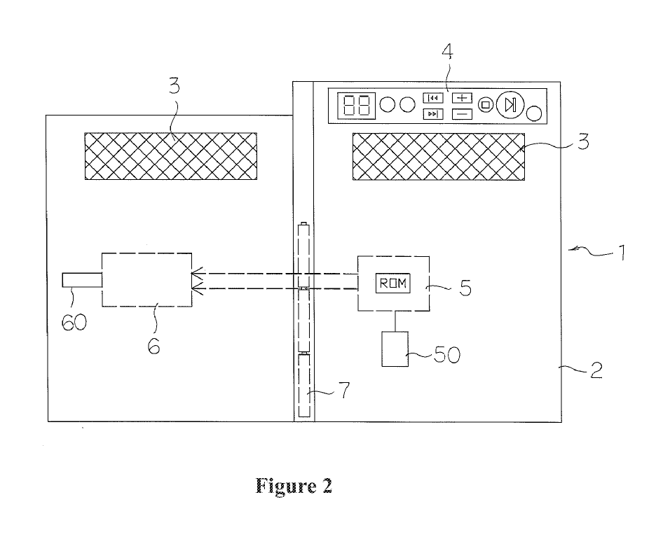

The first preferred embodiment of the auto-play audible publication of the present invention is illustrated in FIGS. 1 and 2; the audible publication 1 is provided with a main body 2, which contains at least one thin speaker 3, a multifunctional play panel 4 electrically connected with the thin speaker 3, a control circuit hoard 5 electrically connected with the thin speaker 3 and play panel 4, a speaker driving flexible circuit board 6 electrically connected with the thin speaker 3 and control circuit board 5, and used to receive signals from the control circuit board 5 to drive the thin speaker 3, as well as a power supply 7 for the aforementioned units.

Said audible publication 1 may include: books, magazines, booklets, notebooks and notepads. For instance, it can be incorporated into an audible book or an audible magazine by aforementioned units, enabling simultaneous reading and audible play; it can also be designed into a booklet with preset voice or music, enabling simultaneous access and voice or music play; it can be designed into various notebooks and notepads, enabling simultaneous music play depending on the individual preference.

In the first preferred embodiment, two thin speakers 3 are set separately onto the front and back covers, whilst a single thin speaker 3 can also be implemented depending on the user demands; besides, as the structure of thin speaker 3 is publicly available to those with relevant skills and knowledge, no detailed drawings or descriptions are given here.

The play panel 4 can be arranged at either side of the thin speaker 3; in this preferred embodiment, it is located overhead the play panel 4; the play panel 4 allows the users to control its functions at least including: play, pause, stop, repeat, change and page display, etc.

The control circuit board 5, serving as a control body with audio output control and storage functions, and provided, with a built-in memory for storing all audio data in the audible publication; moreover, the memory includes: ROM and flash memory 50, etc, of which the flash memory 50 allows to update, expand or change the contents via USB interfacing (shown in FIG. 2).

The speaker driving flexible circuit board 6 is electrically connected with thin speaker 3 via a transmission line, and used to receive startup signal from the control circuit board 5 to drive the thin speaker 3 for providing the audio effect to the users.

The power supply 7 is set in the spine or other location of the book (e.g.: within the front or back cover), and provided with several batteries that are connected in series to supply the required electric power; the battery is available with multiple types such as: dry battery (No. 3 or 4) or button battery, or other kinds of batteries or equivalent ones where applicable; the power supply 7 is also connected with electric device for durable operation.

Said speaker driving flexible circuit board 6 is also fitted with an audio input hole 60, which is connected to earphone for listening purpose (shown in FIGS. 2˜4).

When the audible publication 1 is used, the contents can be selected by the users according to their preference; for instance, after opening and selecting the intended page 20 the users could browse the page of the same contents by the play panel 4, and enjoy the audio effect via the thin speaker 3 or earphone; in such case, the users could listen to music, sing songs and read the audible publication anytime, anywhere.

Given a variety of contents and volumes for the books and magazines relating to said auto-play audible publication 1, the play panel 4 is designed with multiple push buttons for diversified control functions, such as: play, pause, stop and repeat; also, a space-saving touch switch panel 8 is also included to meet the user demands for page selection, paragraph selection, all repeat and partial repeat.

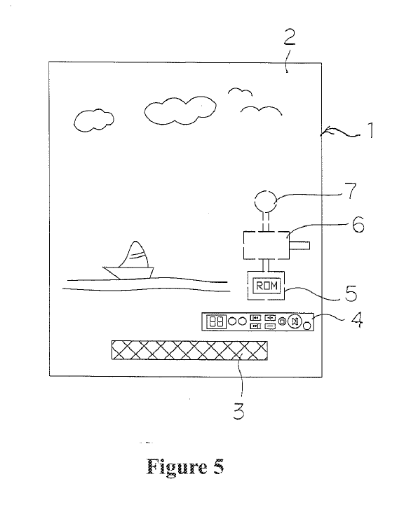

The second preferred embodiment of the auto-play audible publication 1 of the present invention is illustrated in FIG. 5; of which, the audible publication 1 is also provided with a main body 2, which contains at least one thin speaker 3, a multifunctional play panel 4 electrically connected with the thin speaker 3, a control circuit board 5 electrically connected with the thin speaker 3 and play panel 4, a speaker driving flexible circuit board 6 electrically connected with the thin speaker 3 and control circuit board 5, and used to receive signals from the control circuit board 5 to drive the thin speaker 3, as well as a power supply 7 for the aforementioned units.

Said audible publication 1 is a leaflet, newspaper or card. When it is used as an audible leaflet, voice or music can be played simultaneously when reading it; when it is used as an audible newspaper, the voice of the same contents can be played simultaneously when reading it; when it is used as a card, voice or music can be preset to match the themes and played simultaneously, thereby providing various reading patterns.

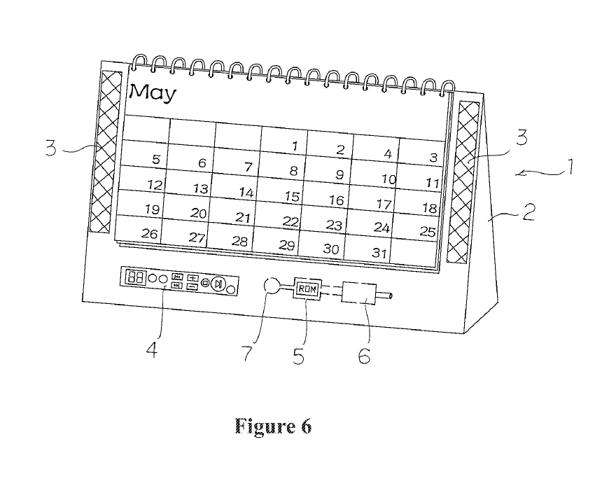

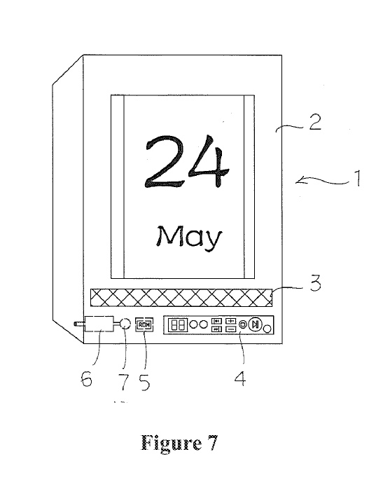

The third preferred embodiment of the auto-play audible publication 1 of the present invention is illustrated in FIGS. 6, 7, wherein the audible publication 1 is a desktop or wall-mounted calendar, which is provided with a main body 2 that contains at least a thin speaker 3, a multifunctional play panel 4 electrically connected with the thin speaker 3, a control circuit board 5 electrically connected with the thin speaker 3 and play panel 4, a speaker driving flexible circuit board 6 electrically connected with the thin speaker 3 and control circuit board 5, and used to receive signals from the control circuit board 5 to drive the thin speaker 3, as well as a power supply 7 for the aforementioned units; of which, the thin speaker 3 is set onto the surface of the main body 2 of the desktop or wall-mounted calendar, but other units are concealed into it or properly onto it.

When faced with the desktop or wall-mounted calendar, the users may play the preset music by the play panel 4; due to the movability of the audible publication 1, it can be accessed anytime, anywhere, thus creating a comfortable atmosphere while enjoying the music.

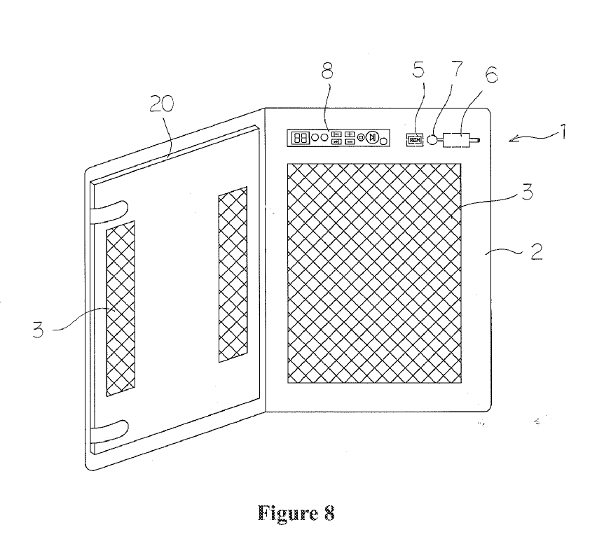

The fourth preferred embodiment of the auto-play audible publication 1 of the present invention is illustrated in FIG. 8, wherein the audible publication 1 is a CD album, religious scripture or journal. Said audible publication 1 is provided with a main body 2, into which multiple pages 20 are arranged; the main body 2 also contains: thin speaker 3, diaphragm touch switch panel 8, control circuit board 5, speaker driving flexible circuit board 6 and power supply 7; similarly, the memory is a ROM or flash memory 50 or a combination, and the speaker driving flexible circuit board 6 is fitted with an audio input hole 60.

When it is used as a CD album, the page 20 in the main body 2 contains various information such as: music items, songs or portraits of singers; and corresponding voice or music contents are stored in the memory; the preferred music items are directly played by the play panel 4 along with songs attached on the page 20, or the portraits of singers are enjoyed, thus permitting to listen to music, sing songs and read the audible publication anytime, anywhere.

When it is used as a religious scripture or journal, the page 20 in the main body 2 contains the scripture for various purposes; and acoustic data relating to the scripture are stored in the memory; after selecting the intended page 20 by the play panel 4, the scripture could be played acoustically through the thin speaker 3, or connected via the earphone to audio input hole 60, thus realizing the functions of simultaneous listening and reading.

To sum up, based on the innovative design of the thin speaker and multifunctional play panel, the “auto-play audible publication” of the present invention could reduce its weight and save its space with higher portability; moreover, the embedded control circuit board, speaker driving flexible circuit board and power supply are incorporated optionally with the flash memory and audio input hole, enabling free and convenient operation and listening by the users.

Although the invention has been explained in relation to its preferred embodiment, it is to be understood that many other possible modifications and variations can be made without departing from the spirit and scope of the invention as hereinafter claimed.

1. An auto-play audible publication comprising a main body; one or more thin speakers; a play panel provided with functions including: play, pause, stop, repeat, change and page display;
a control circuit board, electrically connected with said play panel and said thin speaker, designed with a memory for audio output control and storage; wherein said memory is set for storing audio data with the same contents of the audible publication;
a flexible speaker driving circuit board, electrically connected with said thin speaker, and used to receive startup signal from said control circuit board to drive the thin speaker; and
a power supply, provided with several batteries connected in series to supply the required electric power.

2. The auto-play audible publication as claimed in claim 1, wherein said memory is ROM or flash memory, of which the flash memory allows to update, expand or change the contents via USB interfacing.

3. The auto-play audible publication as claimed in claim 1 or 2, wherein said speaker driving flexible circuit board is fitted with an audio input hole.

4. The auto-play audible publication as claimed in claim 3, wherein said power supply is also connected with electric device for durable operation.

5. The auto-play audible publication as claimed in claim 4, wherein said play panel can be substituted by a diaphragm touch panel.

6. The auto-play audible publication as claimed in claim 1, 2, 4 or 5, wherein said audible publication is either of book, newspaper, magazine, booklet, leaflet, calendar, card, CD album, or notebook, religious scripture/journal.
